(19) United States
(12) Patent Application Publication
(10) Pub. No.: US 2006/0184688 A1
(43) Pub. Date: Aug. 17, 2006

(54) System and Method for Parallel Indirect Streaming of Stored Media from Multiple Sources

(75) Inventors: Samrat Ganguly, Monmouth Junction, NJ (US); Sudeept Bhatnagar, Plainsboro, NJ (US); Akhilesh Saxena, Somerset, NJ (US); Rauf Izmailov, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/276,122

(22) Filed: Feb. 15, 2006

Related U.S. Application Data
(60) Provisional application No. 60/653,729, filed on Feb. 17, 2005.

(51) Int. Cl. G06F 15/16

(52) U.S. Cl. 709/232; 709/231

(57) ABSTRACT

A system and method are herein disclosed for parallel streaming of stored media from multiple sources. The architecture utilizes the notion of indirect streaming and provides a local proxy streaming server which is responsible for interacting with the multiple servers and scheduling downloads of media blocks and for dealing with possible rate fluctuations and server failures.

### CROSS-REFERENCE TO RELATED APPLICATIONS

This application claims the benefit of and is a non-provisional of U.S. Provisional Application No. 60/653,729, entitled “SYSTEM AND METHOD FOR PARALLEL INDIRECT STREAMING OF STORED MEDIA FROM MULTIPLE SOURCES,” filed on Feb. 17, 2005, the contents of which are incorporated by reference herein.

### BACKGROUND OF INVENTION

The invention relates generally to the streaming of media over a network architecture.

With the advent of data networks such as the Internet, a variety of different media distribution architectures have been developed, including peer-to-peer (P2P) networks and content distribution networks (CDNs). Media objects can be replicated at multiple servers, and the clients can directly contact these servers to obtain a copy. The concept of using multiple servers has been thoroughly considered in the context of conventional file transfers and P2P systems. A given file can be split into subfiles and stored at multiple sites. By downloading the subfiles in parallel from multiple sites, the client is able to reduce the total file download time. Recent work in P2P networks exploits the cooperation of peers to further alleviate server load.

Streaming media from multiple servers, however, introduces additional challenging problems. See, e.g., R. Rejaie and A. Ortega, “PALS: Peer-to-peer Adaptive Layered Streaming,” in Proc. of NOSSDAV (2003); T. Nguyen and A. Zakhor, “Distributed Video Streaming over the Internet,” SPIE, Conference on Multimedia Computing and Networking (January 2002); J. G. Apostolopoulos et al., “On Multiple Description Streaming with Content Delivery Networks,” Proc. IEEE INFOCOM (2002). Unlike subfiles in conventional file transfers, media subfiles have real-time deadlines which must be met in order to support a given playback rate at the client. Moreover, connection rate fluctuations (or even a server crash) could reduce the transfer rate and delay a media subfile beyond its playback deadline, even though the subfile would have met its playback deadline had the rate remained constant. Accordingly, there is a need for new system architectures for streaming media content that can adapt quickly to such fluctuations so that playback does not suffer.

### SUMMARY OF INVENTION

A system and method are herein disclosed for parallel streaming of stored media from multiple sources. The architecture utilizes the notion of indirect streaming, where the client does not stream media directly from servers/peers but, instead, has access to a local proxy streaming server which hides the network complexities from the client. The local proxy streaming server is responsible for interacting with the multiple servers and scheduling downloads of media blocks and for dealing with possible rate fluctuations and server failures. By decoupling media playback from media download, this facilitates protocol independence on both the server side and the client side: the local proxy streaming server can mediate between any streaming protocol used by any existing media client and any data delivery protocol used by existing media servers, including incorporating peer-to-peer delivery mechanisms. The architecture thus requires minimal modification of existing media client server installations. In one embodiment, the local proxy streaming server has a block scheduler that uses estimated transfer rates to compute an optimal set of assignments of media blocks to servers. The block scheduler, in another embodiment, uses connection swapping to exploit any delay margin between the different servers. The block scheduler, in another embodiment, uses block splitting where the original block size, given the current estimated transfer rates, is unable to provide assignments that will meet the playback deadlines. The local proxy streaming server can, accordingly, load-balance between servers and can seamlessly handle network changes as well as server failures. The architecture herein disclosed provides for smooth playback while requesting media at a coarse granularity. It is able to deal with network bottlenecks in a scalable manner that does not require coordination between the servers. The architecture advantageously attempts to minimize the load on the media servers by focusing on the transfer and load-balancing of larger contiguous blocks rather than at a packet-level granularity or at the client-level.

These and other advantages of the invention will be apparent to those of ordinary skill in the art by reference to the following detailed description and the accompanying drawings.

### BRIEF DESCRIPTION OF DRAWINGS

FIG. 1 illustrates a streaming architecture constructed in accordance with an embodiment of an aspect of the invention.

FIG. 2 is a flowchart of processing performed by the local proxy streaming server, in accordance with an embodiment of this aspect of the invention.

FIG. 3 is pseudo-code illustrating the processing performed by the block scheduler in assigning blocks to servers.

FIG. 4 is pseudo-code illustrating the processing performed by the block scheduler in choosing a feasible set of connections.

FIG. 5 is pseudo-code illustrating the processing performed by the block scheduler in swapping connections.

FIG. 6 is pseudo-code illustrating the processing performed by the block scheduler in splitting a block into sub-blocks.

### DETAILED DESCRIPTION

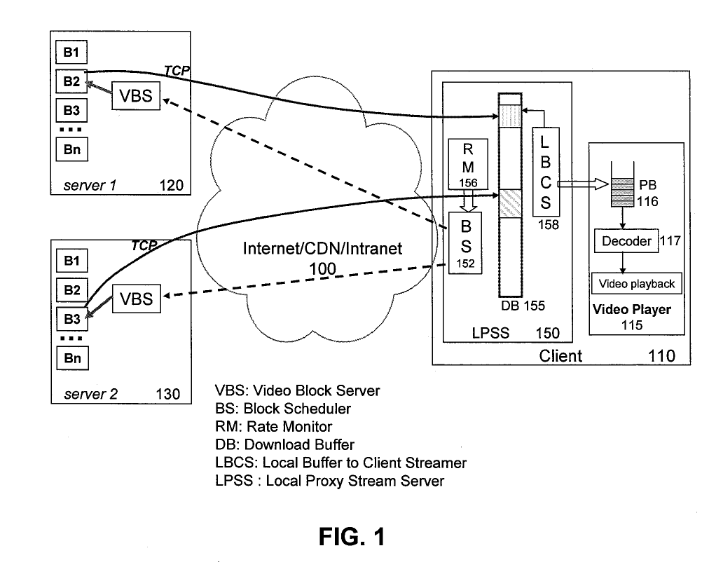

FIG. 1 is an abstract diagram illustrating a streaming architecture constructed in accordance with an embodiment of an aspect of the invention. A client 110 is connected by a transport network 100 to a plurality of servers, e.g., 120 and 130. The present invention is not dependent upon any particular network architecture or transport or flow control mechanism. For illustration purposes only herein, it is assumed without limitation that the Transmission Control Protocol (TCP) is utilized by the client 110 and servers 120, 130.

The servers 120, 130 store media streams which can be delivered to the client 110. The media streams are not limited to any particular form or content. The media streams are preferably encoded in a manner that is optimized for streaming, and the client can include a media player 115 with a decoder 117 which is capable of decoding the media streams. Each media stream is preferably split into a plurality of blocks (segments) where each block can be downloaded independently. Each block represents the pre-specified unit of transfer for the system. The requests for downloads are preferably at the granularity of the blocks unless mandated by the prevailing network conditions. This condition helps minimize the number of requests, which is desirable since each request puts an additional processing load on the server (and also incurs an additional control packet overhead). The i^{th} block is represented herein as Bᵢ with its length denoted as Lᵢ. The size of the blocks could be determined by several factors: for example, memory buffers at servers and the block-level organization of media at a proxy cache. The encoding, for illustration and ease of analysis, is assumed herein to be constant bit rate (CBR) at a bit-rate of r, so that downloading the initial x % of a block Bⱼ, corresponds to an expected playback duration of x % of Lⱼ/r. The playback starting time of block Bⱼ is denoted by sⱼ, its finish time is fⱼ and the two are related as

$${f}_{j} = {s}_{j} + \frac{{L}_{j}}{r} .$$

It is assumed that there is a set of servers which store all the blocks of a given media stream, and that there is a mechanism of identifying which servers store which blocks of the media stream. It is important to note that not all servers need have all the blocks of a media stream. A single server can hold only a partial set of blocks—as long as there exists other servers which store the remaining blocks.

In accordance with an embodiment of an aspect of the invention, the client 110 requests media streams through a component which the inventors refer to as a local proxy streaming server (LPSS) 150—rather than requesting media streams directly from the servers 120, 130.

The LPSS 150 is a component that is responsible for communications with the servers 120, 130 and for hiding the network dynamics from the media player 115. The LPSS 150 can be implemented as a software component that resides on the same client hardware 110 as the media player 115, as depicted in FIG. 1, or can be implemented as a software or hardware proxy in communication with the client machine 110 running the media player 115. As further described below, the LPSS 150 further comprises a block scheduler (BS) 152, a rate measurement (RM) component 156, and has access to a logical buffer referred to herein as the download buffer (DB) 155. The download buffer 155 holds the blocks which arrive before their playback starts and are outside of the playback window. The download buffer 155 can be on disk or in memory and can have any advantageous size.

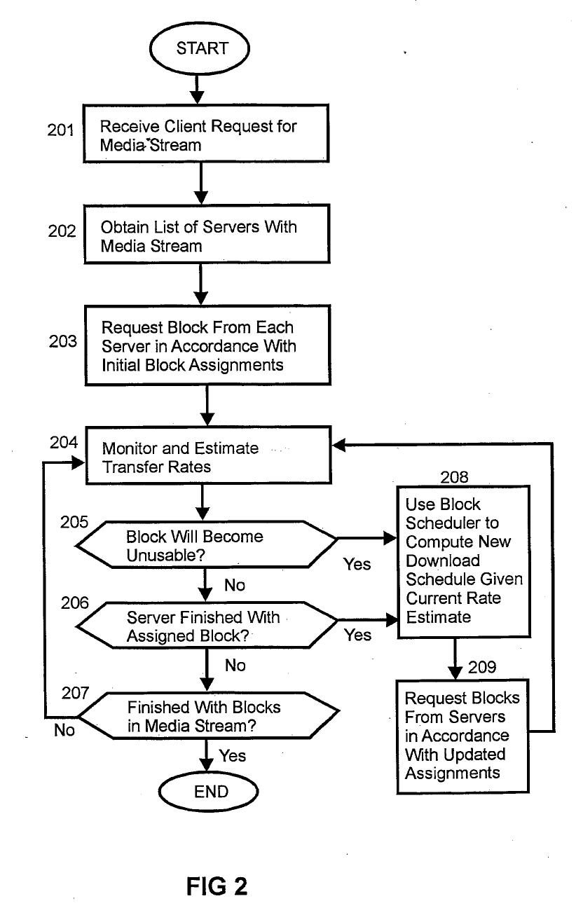

FIG. 2 sets forth a flowchart of processing performed by the LPSS, in accordance with an embodiment of an aspect of the invention. At step 201, the LPSS receives a request from the client for a specific media stream. At step 202, the LPSS proceeds to identify which servers store blocks of the media stream. The LPSS can do this, for example, by contacting a central server or a logical entity inside a content distribution network scheme. The LPSS thereby obtains a list of K servers from which the LPSS could download the media (possibly concurrently from all servers). At step 203, the LPSS proceeds to request blocks from each of the servers in accordance with an initial block assignment composed from the list of identified servers. For example, the LPSS can formulate the initial block assignments randomly and request one block from each identified server. A connection to server j is referred to herein as Cⱼ and the connection's throughput to the LPSS at time t as Rⱼ(t). All Rⱼ(t)s are assumed without limitation to remain quasi-static in the short duration (possibly on the order of a few RTTs) but vary over a long term. At step 204, the LPSS 150 can use the initial assignment of block requests to estimate the transfer rates Rⱼ. The Rⱼ(t)s can be computed by the rate monitoring component using synchronous exponential averaging as Rⱼ(t)=α*Rⱼ(t−δ)+(1−α)*(Rate during last δ) where α is the averaging parameter and δ is the duration of the update interval. At any time t, R₁*(t), R₂*(t), . . . R_{K}*(t) represents the sorted list (in decreasing order) of the TCP transfer rates R₁(t), R₂(t), . . . , R_{K}(t). At all times, γⱼ represents the index of the connection which has the j^{th} fastest connection.

The LPSS can continue to assign blocks to servers in accordance with the initial assignments during a playback buffering stage, while continuing to monitor the transfer rates of the different servers. During the initial buffering, if a server finishes downloading its block, it can be assigned a new pending block which is due to be played next.

If the rate monitoring component of the LPSS detects at step 205 that a block is going to become unusable in the near future, then, at step 208, the LPSS uses its block scheduler to construct a new block download schedule which remains feasible given the current transfer rate estimates. The details of how the block scheduler constructs a new feasible schedule are described below. Then, at step 209, the LPSS can use the new schedule to download the blocks. The LPSS can also invoke the block scheduler when a server finishes its assigned block, at step 206. In this case, when the LPSS sees that a particular block has been downloaded, its server becomes free and it has to be assigned a new block to download. The LPSS can ask the rate monitor to update its estimate of the current transfer rates; then the LPSS can use the block scheduler to compute a new block for the free server. The LPSS can then request that the server send that block next. The LPSS continues to monitor the transfer rates and update the block assignments, where necessary, until the LPSS is finished downloading the media stream at step 207.

With reference again to FIG. 1, as the LPSS 150 downloads blocks from the servers, it places the downloaded blocks into the above-mentioned download buffer 155. It is advantageous for the LPSS 150 to have a local buffer to client streamer (LBCS) component 158 which reads from the download buffer 155 and interacts with the media player 115 in local streaming. The media blocks are routinely transferred from the download buffer 155 to a playback buffer 116 in the media player 115, subject to the maximum playback buffer capacity. Having the media player 115 read the media from its playback buffer 116 further serves to keep it oblivious of the network dynamics handled by the LPSS 150.

In effect, the client 110 and its media player 115 streams the media from the LPSS 150 and not from the servers 120, 130. The inventors refer to this as indirect streaming. Indirect streaming provides a number of advantages. One advantage of this indirection is that it decouples the media playback from media download. Thus, the client media player need not be aware of how, when or from where the media arrived in its playback buffer. The LPSS provides the media download service to the player whose sole task is to play the media. This decoupling allows the optimization of their performance separately. Furthermore, this indirection enables protocol-independence at both server and client side: (1) The LPSS can communicate with different servers using different protocols without the media client being aware of them and (2) The LPSS populates the playback buffer of the client without the servers knowing the specific protocols employed by the client. Thus, any type of server can be used to serve any type of client with the LPSS acting as the communicating and translating media-hub. The devised system requires no special deployment of media-streaming servers; instead, it is able to seamlessly function using any data delivery protocol from the servers to the LPSS including any real-time media streaming standards such as RTP and byte-stream approaches such as HTTP. Moreover, the devised system enables load-balancing between the different media-streaming servers. In the absence of this form of indirection, each media player has to be modified to account for any changes in future. For example, players designed to stream media from a single server have to be modified if they are to incorporate the capability of playing media from multiple servers. Using the LPSS all the players could connect to LPSS and specify what media to stream and LPSS would take care of how to get that media. In fact, the process of adding a new type of media player (with new communication protocols) boils down to having just the LPSS understanding its requirements. The existing server infrastructure, need not be changed at all for the new media player to be of use. Similarly, a change in server-side communication protocol would not require all clients to change their protocol.

Block Scheduling. As discussed above, intelligent block scheduling is advantageous for handling multiple servers and for facilitating a coarse request granularity (for lower load on the servers). Consider, for example, two servers providing rates of 500 KBps and 200 KBps to a client. It is well known that in order to use the servers' bandwidth optimally, the video packets should be downloaded in proportion to these rates. Consider a download of a 7 MB video file from these two servers, where the client sends requests for 1 KB packets. Thus, to download every 7 KB of data in 1 KB packets, the client would ask server 1 to send 5 packets and server 2 to send 2 packets. Note that the total transfer times of these 7 packets from both the servers is 5 KB/500 KBps (or 2 KB/200 KBps)=0.01 sec. Thus, the servers would send the entire 7 KB data in 0.01 second and the client is assured of getting 7 KB of contiguous playback data every 0.01 seconds and after 1 second it would have 700 KB of contiguous playback data. Now consider the case where instead of getting the data in packets of size 1 KB, the client requests the data in blocks of 1 MB. Even now the system has to assign 5 blocks (worth 5 MB data) to server 1 and 2 blocks to server 2, and the download finish time for the entire file is 7 MB/700 KBps=10 seconds (as in the packet level case). However, the amount of contiguous playback data available at different times is different. Server 1 takes 1 MB/500 KBps=2 seconds to download a block and server 2 takes 1 MB/200 KBps=5 seconds to download a block. Suppose server 1 is downloading block 1 and server 2 is assigned block 2. At time 1 second, 500 KB of block 1 would have been downloaded. The portion of block 2 that server 2 downloads is not contiguous with the first half of block 1. Thus the amount of contiguous playback data available after 1 second is 500 KB (in contrast to packet-level download's 700 KB). Clearly, the reason for this reduction in effective playback rate is the coarser granularity of downloads. Alternatively, if server 2 was asked to download block 1, after 1 second, only 200 KB of contiguous playback data would be available!

Thus, determining which block to assign to which server has a significant impact on the playback rate that could be supported. This example, on the other hand, also illustrates a subtle point regarding the request load on the server. While the packet-level requesting results in a higher playback rate, it would send a large number of requests to the servers (in this case 7 MB/1 KB=7000). In contrast, the number of requests generated by the block-level requesting system is limited to 7. While having a large number of requests may be reasonable in the P2P setting, it is undesirable in other contexts. Hence, it is advantageous to find a good middle ground—a solution which does not generate too much control overhead but does not pay much in terms of bandwidth to reduce this overhead.

In the embodiment described above with reference to FIGS. 1 and 2, the LPSS calls the block scheduler when: (1) the rate monitor determines that a block being downloaded might miss its playback deadline, and when 2) a server finishes its assigned block and the LPSS has to assign a new block to that server. It is preferable that the block scheduler assign blocks to servers in a manner that minimizes the probability of a block not being available at its playback time. It is also desirable that the block scheduler be able to deal with transfer rates that can change over the entire playback duration.

The block scheduler takes as an input the current estimated transfer rates R₁(t), R₂(t), . . . , R_{K}(t) and the estimated remaining blocks for each of the servers. The parameter (t) is omitted herein for clarity, since the rates do not need to be changed during a single execution of the block scheduler. The transfer rates are computed by the rate monitor and the LPSS keeps track of the remaining data from each of the server. Using this information, the block scheduler calculates the busy-time βⱼ, of the servers. Since the transfer rates are fixed during the execution, R₁*, R₂*, . . . , R_{K}* and γ₁, γ₂, . . . , γ_{K} are also fixed during the execution. The table below lists the variables used in the discussion below.

TABLE 1
List of variables.

Variables:
Bᵢ - Set of blocks i = 1,2, . . . , N
Lᵢ - Length of block Bᵢ
Serverᵢ - Connection assigned to block Bᵢ
R(i) - Feasible connection set for Bᵢ
r - CBR playback rate
sᵢ - The playback start time of block Bᵢ
fᵢ - The playback finish time of block Bᵢ
R*ⱼ - Sorted rates of Connections j =
1,2, . . . , K
γⱼ - Connection-id of j^{th} fastest connection
βⱼ - Busy time of j^{th} fastest connection
B(i, j) - Busy time of j^{th} fastest connection
just before the instant when Bᵢ is assigned
some connection

The block scheduler has to perform two important tasks: (1) it has to find a suitable block to assign to the free server and (2) it has to check whether the blocks within the look-ahead window (in the foreseeable future) have some feasible server assignment (after accounting for the times the servers would be busy downloading their currently assigned blocks.) In solving the block transfer scheduling problem, it is advantageous to employ the following approach: (1) Get a given block at the earliest possible time subject to all previous blocks arriving at the earliest and its own playback deadline requirements being met, (2) Try to get any block in its entirety in a single request from one server, (3) Ask for sub-blocks only if the block's deadline is not likely to be met if it is downloaded as a whole.

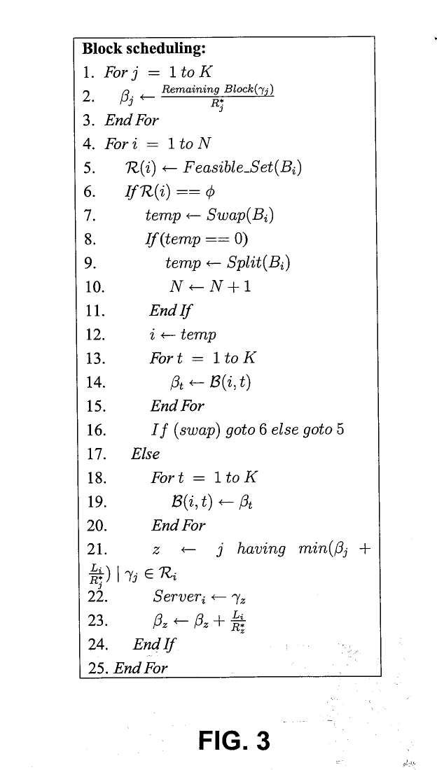

FIG. 3 is pseudo-code illustrating the processing performed by the block scheduler in assigning blocks to servers in accordance with this approach.

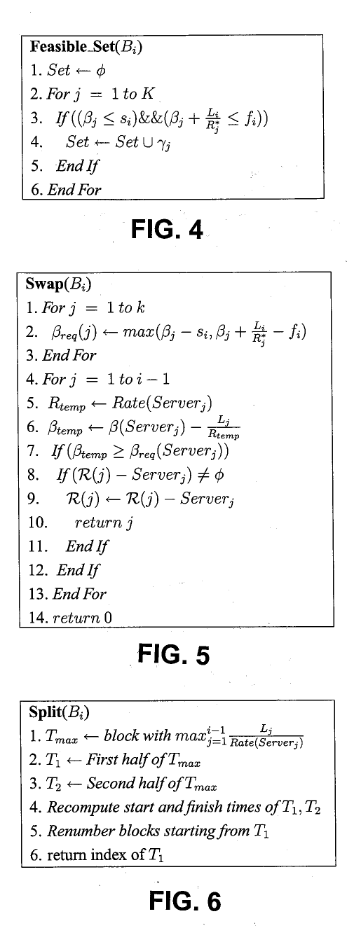

The processing in FIG. 3 starts by assigning the busy times βⱼ of all servers γⱼ to the expected finish time of that server (lines 1-3). Then it starts assigning the servers to blocks in order of their playback start times, thus block B₁ is assigned a server before B₂ and so on. The logic used in this assignment is as follows: In line 5 of FIG. 3, the block scheduler finds the feasible set of connections for the i^{th} block (denoted by R₁). FIG. 4 sets forth the processing performed by the block scheduler in choosing the feasible set of connections for any block. A server is part of the feasible set for a block if it could download the block while meeting both its playback start time sᵢ and its finish time fᵢ, after taking into account the busy time of the server. Note that, since the media encoding is assumed to be CBR, meeting sᵢ and fᵢ implies that a server with constant transfer rate will meet the playback deadline during the block's entire playback duration. For the time being, it is assumed that the feasible set is non-empty for each of the blocks (below the handling of an empty feasible set shall be considered).

Initially all βⱼ are 0 when no blocks are assigned to any server. Say the block scheduler starts from the beginning with block B₁ and assigns connection γ₁ to download it. Clearly, B₁ could not arrive any faster if the block scheduler chooses to download at the prespecified granularity. After this assignment,

$${β}_{1} = \frac{{L}_{1}}{{R}_{1}^{*}}$$

since it could be used to download another block after this time. Next, the block scheduler has to assign block B₂ to some server. The earliest that B₂ can be downloaded is

$$min ( {β}_{1} + \frac{{L}_{2}}{{R}_{1}^{*}} , \frac{{L}_{2}}{{R}_{2}^{*}} ) .$$

So, the block scheduler can assign block B₂ to γ₁ if

$${β}_{1} + \frac{{L}_{2}}{{R}_{1}^{*}} \leq \frac{{L}_{2}}{{R}_{2}^{*}}$$

else assign it to γ₂. If B₂ is assigned to γ₁ its busy time β₁ would increase by

$$\frac{{L}_{2}}{{R}_{1}^{*}}$$

and if assigned to γ₂, its busy time β₂ would increase (from 0) by

$$\frac{{L}_{2}}{{R}_{2}^{*}} .$$

Repeating the above procedure for each block results in the block scheduling approach illustrated in FIG. 3 (except lines 6-20). Lines 21-23 illustrate the logic of assigning a server to a block (from its feasible set) and updating the busy times of those servers. Note that, assigning the server with the minimum download time for a block also increases the chance of that server being feasible for subsequent blocks (because its busy time is incremented by the minimum possible value).

It is desirable to obtain an earlier playback block at an earliest time, subject to the condition that all the previous blocks arrive at their earliest. Applying a block scheduling strategy of “earliest finish assignment” will lead to having the maximum cumulative amount of data at any given time or lexicographically (in block-ids) smallest finish time schedule. Note that this naive strategy amounts to using the earliest deadline first approach with the deadlines being determined by the block playback times. This basic approach is a subset of the one shown in FIG. 3, specifically, it is the portion left after eliminating lines 6-20 (and also eliminating the EndIf statement in line 24). The scheduling strategy is shown to assign the connections to all the blocks even though they might be downloaded from that server only at some distant future. This achieves the objective of testing feasibility for future blocks. The “earliest finish” strategy would be able to find a feasible schedule for all blocks only if each block has at least one server available in the feasible set. However, this is not realistic if all the connection rates are not faster than the playback rate. Hence, the inventors present two additional strategies, swapping and splitting, to compensate for the limitations of the naive earliest finish assignment approach.

Connection Swapping. Since it is an aim of the block scheduler to arrange for the download of a block as a whole from a server, one option to consider is connection swapping. The idea behind connection swapping is to exploit any delay margin that the earliest finish assignment approach leaves. For example, consider a case where the earliest finish strategy assigns a connection to a block which downloads 10 seconds before its playback start and 12 seconds before its finish. Thus, if the block scheduler download the block after a little delay (say 5 seconds before start and 3 seconds before finish) by assigning it to a slower (and possibly busier) server, it would still suffice for the playback purposes. The advantage of this reassignment is that the original (faster) server would have a lower busy time and could help a later block by becoming the sole member of its feasible set. Thus, the block scheduler could populate a block's empty feasible set by reassigning some previously assigned connections while still being able to download the blocks at the specified granularity and meeting their deadlines.

FIG. 5 illustrates the processing performed by the block scheduler in swapping connections assigned to a previous block with Bᵢ if its deadlines can not be met by any available connection. The original earliest finish assignment approach can be used until the point that the block scheduler finds a block for which there is no feasible connection (after accounting for the existing assignments). Consider block Bᵢ to be the first block that has an empty feasible set Rᵢ. The block scheduler tries to find a suitable block starting from B₁ to Bᵢ₋₁ with which if the server for Bᵢ were swapped, all blocks from B₁ to Bᵢ would have a feasible server.

First the block scheduler calculate the amount of reduction required in the busy time of connection j, in order for it to be feasible for Bᵢ. For this the block scheduler computes the required margin as β_{req}(j) in lines 1-3 of FIG. 5 using the actual download start and finish times that connection j would provide for Bᵢ if it were assigned to the block. To find this block, the block scheduler visits the blocks in an increasing order from block B₁ to Bᵢ₋₁. The block scheduler finds the first block Bⱼ for which the following two conditions hold: 1) The reduction in busy time of its server by not downloading Bⱼ is more than β_{req}(j) (FIG. 5, line 7). This makes the server for B₁ a possible candidate to help populate Bᵢ's feasible set R₁. 2) There is a feasible rate in its Rⱼ other than its server (Serverⱼ(FIG. 5, line 8). The block scheduler assigns the slowest feasible connection to Bⱼ so that it leaves maximum margin for error. Moreover, this ensures that Bⱼ will not be of help in any subsequent connection swapping operations, thus reducing the overall run-time of the block scheduler. If the block scheduler finds such a Bⱼ, the block scheduler eliminates its server from its feasible set Rⱼ (FIG. 5, line 9) and returns its connection-id (FIG. 5, line 10) to the assignment procedure in FIG. 3. If such a block is not found, a value of 0 is returned (FIG. 5, line 14).

It can now be seen how this subroutine interacts with the earliest finish assignment approach. If a block for Bⱼ reassignment was found, the assignment procedure gets its id in variable temp (FIG. 3, line 7). An important aspect to note is that since the block scheduler reassigns the server for Bⱼ, all subsequent blocks could have their download times and all servers could have their busy times altered from Bⱼ onwards. Thus, rather than adding a complex strategy, the simplest technique is to use the original earliest finish assignment approach restarting from Bⱼ using the new feasibility set Rⱼ. To do this, the block scheduler resets the value of the index to j (using variable temp in FIG. 3, line 11). Then, the block scheduler reverts to the server busy times as they were just before the time a server was allocated to Bⱼ initially. These busy times are stored in the variable vector B(i,j) in FIG. 3, lines 18-20 and the block scheduler restores them in lines 12-14. Then the block scheduler starts the earliest finish assignment process starting at block Bⱼ with its new feasible set. It avoids the recomputation of feasible set on line 5 thus eliminating the originally assigned server from consideration.

Note that the swapping strategy embodiment disclosed here is a simple heuristic and does not cover all possible combinations (to avoid time complexity) of rate assignments to try and meet a block's deadline. One should note that the swapping strategy works recursively toward finally meeting the deadlines. Lastly, it is possible that no swapping operations reach a feasible server assignment for every block. In such a case, the block splitting strategy described next can be adopted.

Block Splitting. The insight behind block splitting is that the granularity of busy times of a connection is at the level of a block. So if a large block is stuck with a slow connection, it would take a long time to download. If this block were divided into two smaller blocks, they could be downloaded in parallel using two separate connections. Effectively, block splitting allows the system to increase the transfer rate assigned to the original block. Note that splitting at the finest possible granularity is not desirable because of the possible overhead at the server end.

FIG. 6 illustrates processing performed by the block scheduler to arrange for the splitting of blocks into smaller sub-blocks if the deadlines of Bᵢ cannot be met by the basic scheduling approach and swapping. The block scheduler chooses the block with maximum download time as the block to be split. The reason for this is that breaking up this block could provide the maximum amount of time gained in terms of server busy time. The block scheduler breaks this block into two halves and recompute the feasibility sets of the blocks to see if the new set of blocks has a feasible server assignment. The process is repeated until such a feasible assignment is obtained.

With reference to FIG. 6, the first line finds the block with the maximum download time as the block of choice of splitting, because as mentioned above, breaking up this block could provide the maximum amount of time gained in terms of server busy time. Next, the block scheduler break up this block into two halves and recomputes their start and finish times. Since there is one additional block (T₂) in the block list, all subsequent blocks are renumbered. The index of T₁ is returned to the processing in FIG. 3 at line 9. It updates the number of blocks (line 10) and falls through to do exactly as for swapping, i.e., restores the βⱼ values to what they were before the current block. Unlike connection swapping, it is advantageous to now recompute the feasibility set. For swapping, it is preferable not to perform the re-computation because it is desirable to curtail the feasible set to eliminate the swapped connection. Here, the feasibility set is entirely new because the block at which the reassignment starts is absolutely new. This is taken care of in line 16 where if the processing is identified to have came from the swap routine, control passes to line 6 else to line 5.

It should be noted that it is preferable to limit the splitting granularity. The earliest finish assignment strategy and the connection swapping strategy do not increase the number of blocks (sub-blocks). The splitting strategy, however, results in extra blocks and hence could result in extra processing and control packet overhead at the server. It is preferable that the block scheduler use splitting only in if the other two strategies fail. Furthermore, it is preferable that the block scheduler only split blocks until a certain size limit (1 KB for example). If even at that size it is not possible to construct a feasible schedule, the system incurs a missed playout penalty.

It also should be noted that it is preferable that the block scheduler use the above strategies—earliest finish assignment, swapping, and splitting—on only the blocks within the look-ahead window (and not for all the blocks). This reduces the processing time significantly without affecting the performance since trying to check feasibility of blocks far in future based on the current transfer rates is futile. Since the rates are bound to change over a period of time, the feasibility testing is meaningless. Having too large a look-ahead could also result in excessive block splitting. Consider the case where the connection rates reduces drastically due to congestion. In such a case, the block scheduler would end up splitting blocks which are quite far in time. Hence, it is preferable that the implementation provide the capability to re-merge the sub-blocks into one if none of the sub-blocks was the one assigned for download to any server. Furthermore, it is preferable to provide the capability of re-merging the contiguous sub-blocks which the block scheduler assigns to the same server.

It should be noted that the term “server” as utilized herein refers also to other client peers which can act as a “server” in a peer-to-peer network. For example, an LPSS can find other LPSS's which have downloaded the same media content through a tracker service implemented by the content provider, analogous to the tracker services provided by conventional peer-to-peer service such as BitTorrent. A tracker can be used to maintain information about all LPSS nodes in the system. As the LPSS obtains the initial server list from the content provider, the server list can also include address information on LPSS peers which can also serve the content. The process of selecting a subset of servers and peer LPSS nodes from which the blocks are downloaded using the block scheduler, described above, can proceed as follows. With respect to a given LPSS, there are three key parameters that decide the choice of peers/servers: (i) sustained transfer rate between the peer/server and the requesting LPSS, (ii) the difference in playback time between the requesting LPSS and the peer LPSS—the further ahead the other peer LPSS is in the download process, the greater is the amount of additional data it can provide to the requesting LPSS; and (iii) the duration of time the other LPSS is expected to stay in the system—a peer that is expected to disappear from the system quickly is expected to be less useful to the requesting LPSS. If it is assumed that there are no shared points of congestion on network paths, then the problem of server/peer selection can be performed using the following heuristic. Consider where the source is another LPSS peer (the case where the server is not a peer follows analogously). Let the requesting peer be labeled P₁ and a source peer be labeled P₂. Let r₁ denote the aggregate received rate of P₁ without having chosen P₂ as a source node. Let r_{1,2} denote the possible rate achievable between P₁ and P₂. Let r₂ denote the aggregate received rate of P₂ (if P₂ is a server, then r₂ is 0). Let β₁ and β₂ indicate the (continguous) bytes already downloaded by the two peers. Now consider the case where P₁ chooses P₂ as a source of data. In general, if r₁+r_{1,2} is higher than r₂, then potentially P₁ will catch up with P₂ after a time t*, given by:
(r₁+r_{1,2})t*rr₂t*+(β₂−β₁)
That is

$${t}^{*} = \frac{{β}_{2} - {β}_{1}}{{r}_{1} + {r}_{1 , 2} - {r}_{2}}$$

In such a case, the total useful bytes downloaded by P₁ from P₂ is given by r_{1,2}t*. If, however, P₂ leaves the system at time t′ prior to P₁ cathing up with it, e.g., if r₁+r_{1,2} is less than r₂, the total useful bytes downloaded by P₁ from P₂ is given by r_{1,2}t′. Therefore, among multiple alternate choices in a set of self-congesting peers, it is advantageous to choose a peer that can provide the highest amount of data to the requesting peer. This is given in either case by r_{1,2}t, where t=t* if P₁ catches up with P₂, and t=t′ otherwise. This heuristic can be iteratively evaluated in the long term to continuously update the selection of peers from which to download blocks. The heuristic can be readily implemented, since the current aggregate download rate of each LPSS is reported and can be made available in the tracker. Based on this information and short bandwidth tests between a pair of candidate nodes, the appropriate peer/server selection choices can be made.

In the above description, the rate monitoring component of the LPSS uses passive mechanisms to measure the connection rates. It should be noted that alternative mechanisms can be utilized, including active measurement of the connection rates. This can be advantageous particularly in the initial start phase and when a server is idle (not downloading any blocks). The LPSS can request that the servers advertise the bandwidth using active probing tools. Alternatively, the rate monitoring component of the LPSS could also use pseudo-passive measurement by letting the servers send some data which is not required within the look-ahead window.

Although the above description discusses CBR media stream, the invention is not so limited. For example, the block scheduling approach described above can be readily extended to the situation in which the encoding is VBR for the entire video but is, nevertheless, blockwise-CBR. Thus, a block could be CBR in itself but its bit-rate could be significantly different from another block. The above description is directly applicable to this situation because the downloads work at a block level and the only intra-block information is used in making any decision. In general, as long as a function is available to find whether a given transfer rate is feasible for a block, the type of encoding of the block would not be an issue for the above streaming architecture.

The disclosed architecture can also be adapted to handle layered encoding. Since the above-described streaming architecture deals with the media at block levels, it is natural to think of different portions (in time) of the layers as different blocks. A key difference from the single-layered media is that now several blocks (from different layers) could have the same playback start and finish times. This, however, does not require any changes in the architecture since the only thing that concerns the system is the feasible set of servers for each block. The system has the ability to adaptively download only lower layers if no swapping/splitting is able to download all the layers.

The above streaming architecture should increase the effective download rate of clients by effectively managing the concurrent download from multiple servers. It should be noted moreover that the above streaming architecture should be advantageous even for clients with a slow access link, given its inherent fault tolerant capability. If the network botteneck is at the access, a single connection might suffice for the client. The LPSS and the block scheduler would, in this case, choose one of the servers randomly and stick to it. However, if the bottleneck is inside, the approach proposed will try to avoid it by choosing a less bottlenecked connection (path) for download.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

What is claimed is:

1. A proxy for indirect streaming of media to a media client from a plurality of servers, the proxy comprising:
a rate monitor which estimates transfer rates from the plurality of servers to the proxy;
a block scheduler which assigns blocks of a media stream to be requested from the plurality of servers so as to ensure that each downloaded block meets a deadline, and, where a block does not meet a deadline, which reassigns remaining blocks of the media stream so as to meet the deadline based on current transfer rates estimated by the rate monitor.

2. The proxy of claim 1 wherein the block scheduler maintains feasability sets of servers which could feasibly download a block and meet the deadline for the block and wherein the block scheduler assigns the block to a server in the feasability set with an earliest download finish time.

3. The proxy of claim 2 wherein the block scheduler reassigns blocks in order to populate an empty feasiblity set with a server whose block has been reassigned.

4. The proxy of claim 2 wherein the block scheduler recomputes the feasibility sets after splitting a large block of the media stream into at least two smaller blocks.

5. The proxy of claim 2 wherein the block scheduler computes the feasibility sets within a pre-determined look-ahead window.

6. The proxy of claim 1 wherein the proxy is a local proxy running on a same machine as the media client.

7. The proxy of claim 6 wherein the proxy has access to a media buffer for the media client and wherein the proxy inserts downloaded blocks of the media stream directly into the media buffer.

8. The proxy of claim 1 wherein the plurality of servers includes another media client's proxy acting as a peer.

9. The proxy of claim 1 wherein the proxy uses the transmission control protocol when communicating with the servers and the media client.

10. A method of scheduling downloads of blocks of a media stream from a plurality of servers for indirect streaming to a media client, the method comprising:
estimating transfer rates from the plurality of servers;
maintaining a feasability set of servers which identifies which servers in the plurality of servers could feasibly transfer a block and meet a deadline for the block;
assigning the blocks of the media stream to the plurality of the servers based on the estimated transfer rates and the feasability set so as to ensure that each downloaded block meets a deadline for the block.

11. The method of claim 10 wherein blocks are assigned to a server in the feasability set for the block with an earliest download finish time.

12. The method of claim 10 wherein blocks are reassigned in order to populate an empty feasiblity set with a server whose block has been reassigned.

13. The method of claim 10 further comprising the step of splitting a large block of the media stream into at least two smaller blocks and recomputing the feasibility set based on the smaller blocks.

14. A computer-readable medium comprising instructions which when executed on a computer performs a method of scheduling downloads of blocks of a media stream from a plurality of servers for indirect streaming to a media client, the method comprising:
estimating transfer rates from the plurality of servers;
maintaining a feasability set of servers which identifies which servers in the plurality of servers could feasibly transfer a block and meet a deadline for the block;
assigning the blocks of the media stream to the plurality of the servers based on the estimated transfer rates and the feasability set so as to ensure that each downloaded block meets a deadline for the block.

15. The computer-readable medium of claim 14 wherein blocks are assigned to a server in the feasability set for the block with an earliest download finish time.

16. The computer-readable medium of claim 14 wherein blocks are reassigned in order to populate an empty feasiblity set with a server whose block has been reassigned.

17. The computer-readable medium of claim 14 further comprising the step of splitting a large block of the media stream into at least two smaller blocks and recomputing the feasibility set based on the smaller blocks.
